(19) United States
(12) Patent Application Publication
(10) Pub. No.: US 2018/0224247 A1
(43) Pub. Date: Aug. 9, 2018

(54) ARMOURED VEHICLE

(71) Applicant: NP Aerospace Limited, Coventry, West Midlands (GB)

(72) Inventors: Christopher Davies, Coventry, West Midlands (GB); Michael Sandercott, Coventry, West Midlands (GB)

(21) Appl. No.: 15/749,671

(22) PCT Filed: Aug. 5, 2016
(86) PCT No.: PCT/GB2016/052437

§ 371 Date: Feb. 1, 2018

(30) Foreign Application Priority Data
Aug. 7, 2015 (GB) 1514022.1

(51) Int. Cl. F41H 7/04; F41H 5/04; B32B 5/26; B32B 7/12

(52) U.S. Cl. CPC F41H 7/044; F41H 7/048; F41H 5/0485; B32B 5/26; B32B 7/12; B32B 2571/02; B32B 2363/00; B32B 2307/546; B32B 2307/72; B32B 2262/106; B32B 2262/0269; B32B 2262/101; B32B 2305/188

(57) ABSTRACT

A vehicle comprises ● a composite passenger compartment (1) comprising a structural shell formed wholly or in part of a glass fibre containing composite material comprising a plurality of layers of fibrous material bonded with a resin;● applique armour (5-9) mounted to the composite passenger compartment wherein the plurality of layers of fibrous material comprise both glass fibres and fibres providing in composite form a greater ballistic resistance per unit mass than the glass fibre.

This invention relates to armoured vehicles.

Armour for vehicles has to meet a number of constraints. Vehicle armour needs to:
protect against the different types of threat a vehicle is expected to encounter;
be of sufficiently low weight as not to unduly impede vehicle speed; and
be of sufficiently low bulk as not to unduly impede vehicle manoeuvrability.

Armoured vehicles have to meet a variety of requirements and one requirement they have to meet is to provide a designed level of occupant protection without excessive weight to the vehicle.

It is known to provide vehicles with add-on armour (so-called “appliqué” armour) in the form of plates or other shapes of armour mounted to the vehicle. This armour enables the vehicle's protection level to be tailored to a specific threat scenario.

One sort of armour panel or shape comprises one or more ceramic plates or bodies encapsulated by a sheath of polymeric material. For example, armour is known in which a plurality of ceramic tiles or pellets, frequently hexagonal although possibly of other shapes, are assembled together in a spaced relationship with resilient material therebetween, and confined between a pair of sheets that provide environmental protection and structural rigidity to the assembly [see for example U.S. Pat. No. 6,826,996, EP1734332, WO2006/103431, WO2014/016541, and WO2014/140531]. The sheets further provide a level of spall protection in the event of failure of or damage to the ceramic.

Such armour can be mounted to vehicles in a variety of ways and is typically spaced from the vehicle body either by an air gap or with a foam or other resilient or frangible material between the armour and the vehicle body.

The appliqué armour may comprise not only ceramic elements and the polymeric sheath but also further layers of ballistic fabrics to capture fragments produced on any failure of, or damage to, the ceramic armour. The ballistic fabrics may include, any fibre providing a spall capture function. Fibres that have been proposed for such applications include para-aramid fibres, ultra-high molecular weight polyethylene fibres (UHMWPE), polybenzoxazole (PBO) fibres, carbon fibres, silk fibres, polyamide fibres, polyester fibres, poly{2,6-diimidazo[4,5-b:40; 50-e]-pyridinylene-1,4(2,5-dihydroxy)phenylene} (“PIPD”) fibres, and glass fibres.

Light vehicles to which appliqué armour is applied include conventional vehicles or vehicles having a designed ballistic resistant passenger compartment. It is known to provide a passenger compartment of generally monocoque construction, comprising a single structural shell with apertures for doors, windows and hatches, mounted to a chassis; or as a shell defining the walls and roof of the passenger compartment with a separate floor panel. Such constructions permit the passenger compartment to act as a single body in the event of a ballistic incident. Typically the passenger compartment is made of glass fibre reinforced plastics material [GFRP] since that provides adequate stiffness and rigidity to support appliqué armour and provides a degree of ballistic protection.

A problem that can arise with appliqué armour is having a passenger compartment of sufficient strength and rigidity to mount the varying levels of applied armour that may be required for varying threats. Heavy armour requires a high rigidity compartment for successful mounting, and that can lead to increased weight in the compartment to match the increased weight of the armour.

The present invention is based on the realisation that while GFRP provides a stiff material providing some ballistic protection, other fibre reinforced plastics materials, while of lower stiffness than GFRP, provide a greater ballistic resistance per unit mass than GFRP. Thus, a composite comprising layers of GFRP materials with layers providing a higher degree of ballistic protection than GFRP, can provide the same level of ballistic protection for a lesser weight than either a wholly GFRP or wholly ballistic fibre product.

Accordingly the present application discloses a vehicle comprising:
a composite passenger compartment comprising a structural shell formed wholly or in part of a glass fibre containing composite material comprising a plurality of layers of fibrous material bonded with a resin;
appliqué armour mounted to the composite passenger compartment

characterised in that the plurality of layers of fibrous material comprise both glass fibres and fibres providing in composite form a greater ballistic resistance per unit mass than the glass fibre.

The plurality of layers of fibrous material may comprise:
a plurality of layers comprising glass fibre
a plurality of layers comprising fibres providing a greater ballistic resistance per unit mass than the glass fibre.

Examples of fibres providing a greater ballistic resistance per unit mass than the glass fibre may, for example, comprise fibres selected from the group aramid fibres, ultra-high molecular weight polyethylene fibres, polybenzoxazole (PBO) fibres, carbon fibres, silk fibres, polyamide fibres, polyester fibres, poly{2,6-diimidazo[4,5-b:40; 50-e]-pyridinylene-1,4(2,5-dihydroxy)phenylene} (“PIPD”) fibres, and mixtures thereof.

By “ballistic resistance” is meant the ability to resist a ballistic attack measured by any suitable means, for example NATO Standardization Agency Standardization Agreement 2920 (NSA STANAG 2920).

By “in composite form” is meant that ballistic resistance is measured on a composite comprising the fibres in question.

The scope of the invention is as set out in the appended claims with reference to the following illustrative, but non-limitative description with reference to the drawings in which:

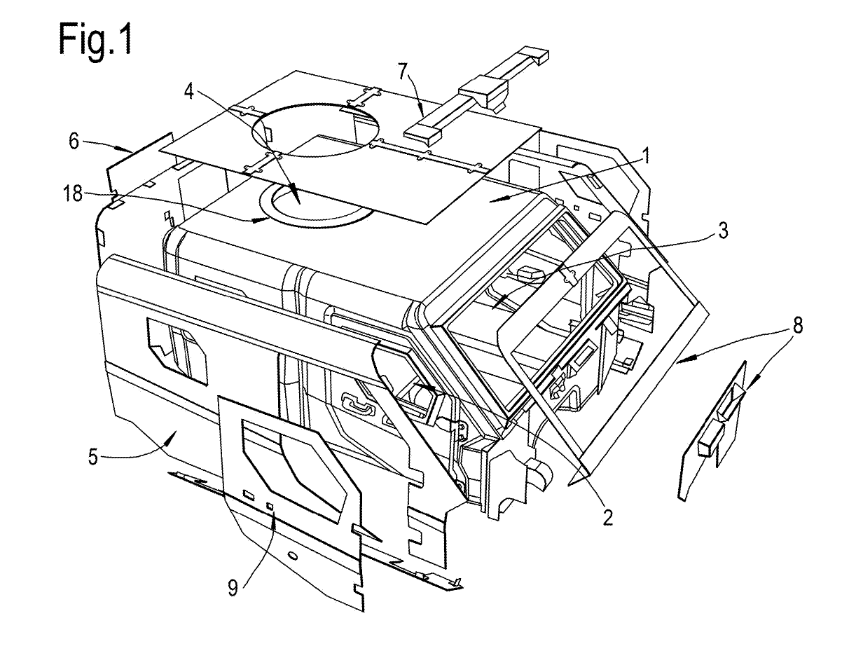

FIG. 1 is an exploded view of a vehicle in accordance with the present disclosure;

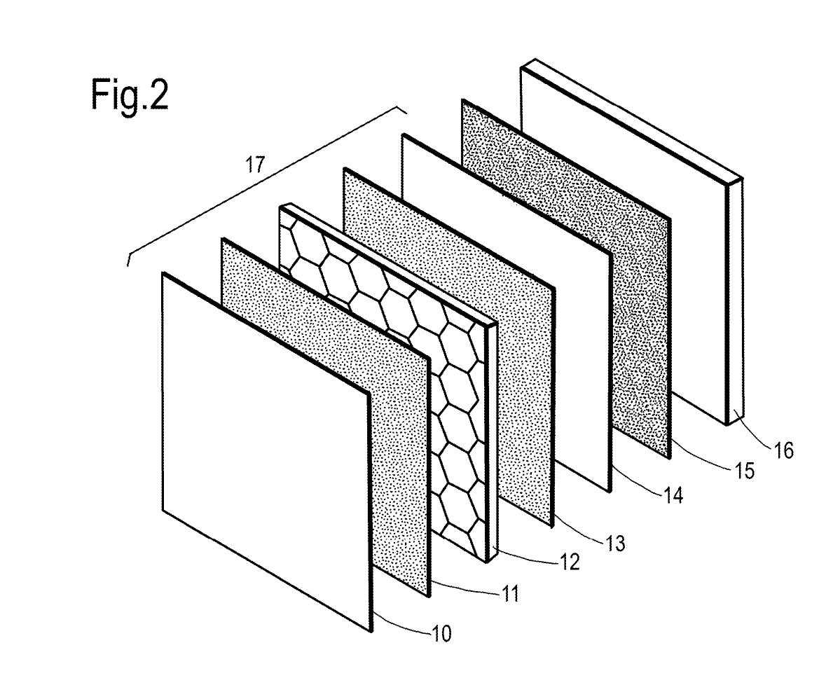

FIG. 2 is an exploded section of appliqué armour mounted to a part of a vehicle in accordance with the disclosure.

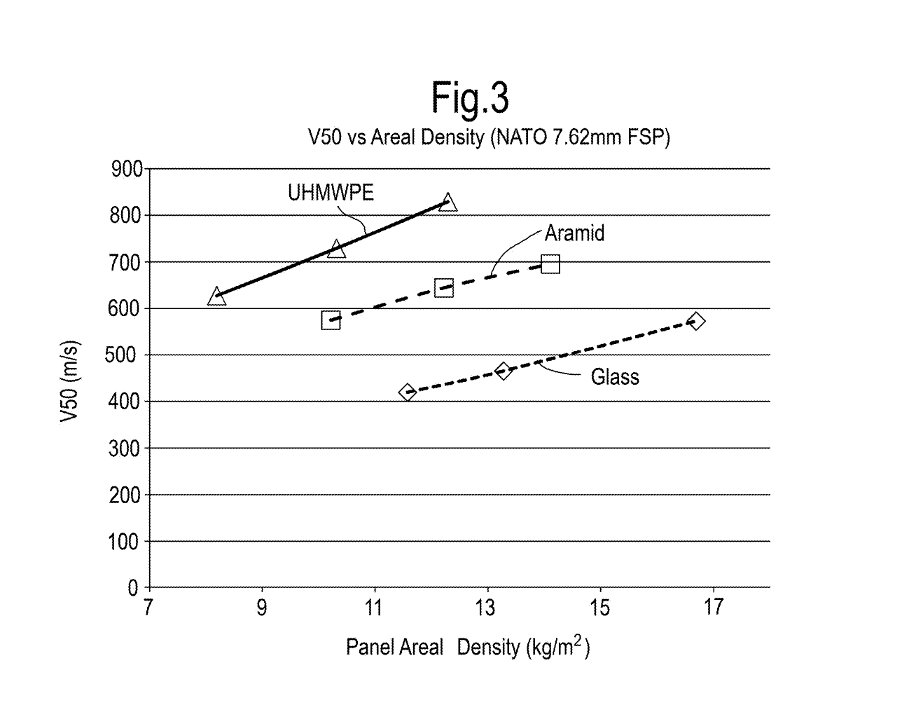

FIG. 3 is a graph indicating relative ballistic performance of composites comprising different fibres.

In FIG. 1 an armoured passenger compartment for a vehicle is disclosed comprising a composite body 1. The body comprises door apertures [shown closed with door 2], window apertures [shown closed with window 3], and a roof aperture 4 to mount a turret [not shown].

Appliqué armour panels and shapes 5,6,7,8; and 9, are mounted respectively to the walls, rear, roof, and front of body 1; and doors 2.

The nature of typical applique armour is shown in FIG. 2 and comprises a ceramic panel 12[which as shown comprises a plurality of hexagonal plates] mounted between polymeric sheaths 10, 14 which may be of a single polymer or of composite construction and joined to the sheaths 10,14 by adhesive 11,13. A foam layer 15 spaces the applique armour 10-14 [shown jointly as 17] from the material of the passenger compartment [shown in part as hull portion 16]. It is in the nature of appliqué armour that the present disclosure is not limited to this type of armour and any armour appropriate to the threat situation and mountable on the passenger compartment is intended as part of the claimed invention.

The appliqué armour may be mounted in any manner to the passenger compartment and the present invention is not limited to the manner of application. Typical means might include mechanically fastened (e.g. bolted/clamped), and permanent or semi-permanent adhesion.

The appliqué armour is typically mounted in spaced relationship to the passenger compartment with either an air gap, or foam (as indicated in Fig.2) or other low density interlayer between passenger compartment and appliqué armour.

Where mechanically fastened, mounting of the appliqué armour is typically by using mounting fixtures engaging predefined mounting points in the passenger compartment. For example the mounting fixtures may comprise bolts and spacers, the bolts engaging the predefined mounting points (e.g. sockets or apertures), and the spacers providing a spaced relationship between appliqu armour and passenger compartment. However, any suitable mounting means may be provided. For example, rivets may be used in place of bolts, and spacers may be omitted when a foam or other low density interlayer is provided between passenger compartment and appliqué armour.

A vehicle comprising a passenger compartment as set out in this disclosure, and appliqué armour may be supplied as a kit of parts, so that the vehicle may have different appliqué armour applied to suit the level of threat.

The composite body 1 is formed in part at least of a glass fibre containing composite material comprising a plurality of layers of fibrous material bonded with a resin, in which the plurality of layers of fibrous material comprise both glass fibres and fibres providing a greater ballistic resistance per unit mass than the glass fibre.

The fibres may be distributed uniformly, with the layers comprising both glass fibres and the fibres providing a greater ballistic resistance per unit mass than the glass fibre. Or the layers may comprise different mixes of fibres. Conveniently the glass fibres are in some layers and the fibres providing a greater ballistic resistance per unit mass than the glass fibre are in other layers. Layers comprising glass fibres, or groups of such layers, may be sandwiched between layers of the fibres providing a greater ballistic resistance per unit mass than the glass fibre, or groups of such layers.

There may be other layers that do not comprise ballistic fibres.

The layers may comprise unidirectional fibres or woven fabrics.

Typically the composite material comprises at least five of the layers, but a sufficient number of layers should be provided to meet the required stiffness and ballistic performance of the composite. Composites comprising >10, >20, >30 or even >40 layers are contemplated.

A typical required flexural strength might be in excess of 100 MPa, 120 MPa, 140 MPa, 160 MPa, 180 MPa, or 200 MPa.

Table 1 below shows typical properties for composites comprising S2 Glass fibres and para-aramid fibres.

TABLE 1

| Property | S2 Glass | Aramid | Units |
|---|---|---|---|
| Tensile Strength | 509 | 1850 | MPa |
| Interlaminar Shear Strength | 18.9 | 9 | MPa |
| Flexural Strength | 219 | 21 | MPa |
| Flexural Modulus | 26.7 | 3 | GPa |

As can be seen, aramid has a higher tensile strength, but lower flexural strength and modulus, and interlaminar shear strength, than the S2 glass GFRP. By mixing varying proportions of glass fibre and aramid layers, the flexural strength of the composite may be “tuned” to lie between the extremes of the aramid and glass fibre to provide a desired stiffness.

FIG. 3 shows a graph of V50 [the projectile velocity at which 50% of stated projectiles defeat the armour] plotted against areal density for panels formed from a range of composite materials comprising fibres bonded by resins. It can be seen that the greatest ballistic protection per areal density is obtained from an ultra-high molecular weight polyethylene, followed by an aramid, followed by a glass phenolic composite.

Thus:
To obtain a desired ballistic protection from GFRP would require a greater mass of material than for aramid or polyethylene.
To obtain a desired stiffness from aramid or polyethylene would require a greater mass of material than for GFRP.
By provision of a blended composite, a lower mass is required to provide both desired ballistic protection and stiffness.

Provision of a single composite body [rather than two separate bodies respectively of GFRP composite and aramid/polyethylene composite] enables both material types to contribute to overall stiffness of the body.

As an example of the invention, the body 1 may be in part of hybrid construction comprising layers of Glass Fibre Reinforced Plastic (GFRP) and Aramid.

A typical construction might be as shown in Table 2 below to give a total structural composite element of such a system having a moulded thickness of 15.9 mm and an areal density of 28.9 kg/m².

With a wholly GFRP passenger compartment of equivalent ballistic and structural performance, the vehicle walls would need to be thicker to provide adequate ballistic performance. A cabin to meet the equivalent ballistic requirement in GFRP would have an Areal mass of 34 kg/m², although the structure only requires 27 kg/m² GFRP to provide equivalent stiffness for vehicle performance. To meet both the stiffness and ballistic requirements the product of Table 2 uses ˜25.6 kg/m²GFRP+˜3.3 kg/m²Aramid, providing matching capability to an all GFRP structure at about 15% saving in mass.

TABLE 2

| | | | | Areal |
|---|---|---|---|---|
| | | Thickness | Density | Density |
| Layers | Material | (mm) | (g/cm³) | (kg/m²) |
| 1-24 | Phenolic resin impregnated S2 Glass composite | 13.1 | 1.96 | 25.64 |
| | comprising a glass woven roving being a plain | | | |
| | weave with a nominal 2 rovings per cm in the | | | |
| | warp direction and | | | |
| | 2 rovings per cm in the fill direction, and a fabric | | | |
| | weight, before prepregging, | | | |
| | of 815 ± 20 grams per square metre, including | | | |
| | surface size. The surface of the woven roving | | | |
| | being treated with an epoxy silane coupling | | | |
| | system and embedded in a phenolic resin. | | | |
| 25-31 | Phenolic resin impregnated aramid composite | 2.8 | 1.16 | 3.26 |
| | comprising Kevlar ® [a DuPont trademark] K129 | | | |
| | Aramid 3140 dtex high tenacity fibre using a | | | |
| | DuPont 258H Plain weave, 1 × 1 warp: 1570 dtex/ | | | |
| | weft: 1570 dtex 13 × 13 ends/picks per cm | | | |
| | having a mass per unit area of 400 ± 5 grams per | | | |
| | square metre with an applied polyvinyl butyral | | | |
| | (PVB) modified phenolic formaldehyde resin | | | |
| | with a resin mass per unit area 55 grams per | | | |
| | square metre | | | |

An alternative construction is as set out in Table 2A below, and comprises a mixture of GFRP and UHMW polyethylene composite and provides matching capability to an all GFRP structure at about 5% saving in mass.

TABLE 2A

| | | | | Areal |
|---|---|---|---|---|
| | | Thickness | Density | Density |
| Layers | Material | (mm) | (g/cm³) | (kg/m²) |
| 1-23 | Phenolic resin impregnated S2 Glass composite | 12.5 | 1.96 | 24.5 |
| | comprising a glass woven roving being a plain | | | |
| | weave with a nominal 2 rovings per cm in the | | | |
| | warp direction and | | | |
| | 2 rovings per cm in the fill direction, and a fabric | | | |
| | weight, before prepregging, | | | |
| | of 815 ± 20 grams per square metre, including | | | |
| | surface size. The surface of the woven roving | | | |
| | being treated with an epoxy silane coupling | | | |
| | system and embedded in a phenolic resin. | | | |
| 24-48 | Dyneema ® BT10. | 6.5 | 1.00 | 6.5 |
| | Dyneema ® Brand UHMWPE tape, woven at | | | |
| | 0/90° | | | |
| 49 | Phenolic resin impregnated S2 Glass composite | 0.6 | 1.96 | 1.18 |
| | comprising a glass woven roving being a plain | | | |
| | weave with a nominal 2 rovings per cm in the | | | |
| | warp direction and | | | |
| | 2 rovings per cm in the fill direction, and a fabric | | | |
| | weight, before prepregging, | | | |
| | of 815 ± 20 grams per square metre, including | | | |
| | surface size. The surface of the woven roving | | | |
| | being treated with an epoxy silane coupling | | | |
| | system and embedded in a phenolic resin. | | | |

For areas not open to direct fire and requiring less structural stiffness, such as the vehicle roof and floor, the body may simply use a GFRP material, for example at 22 ply thickness to give a moulded thickness of 12 mm and an areal density of 23.5 kg/m².

Alternatively, all of the roof, or some regions of the roof, may require additional stiffening to mount heavy objects {e.g. weapons, seats, ammunition or equipment boxes} and required areas may comprise an alternative composite [see for example weapons mounting ring 18 (FIG. 1)]. A suitable material comprises a high flexural strength carbon fibre composite and an example is set out in Table 3 below.

TABLE 3

| | | | | Areal |
|---|---|---|---|---|
| | | Thickness | Density | Density |
| Layer | Material | (mm) | (g/cm³) | (kg/m²) |
| 1 | 2 × 2 Twill weave carbon fibre, fabric weight | 0.25 | 1.6 | 0.4 |
| | 300 gsm. Impregnated with a toughened epoxy | | | |
| | resin | | | |
| 2-10 | T700 Unidirectional carbon fibre fabric. | 4.5 | 1.6 | 7.2 |
| | Impregnated with a toughened epoxy resin. | | | |
| 11 | 2 × 2 Twill weave carbon fibre, fabric weight | 0.25 | 1.6 | 0.4 |
| | 300 gsm. Impregnated with a toughened epoxy | | | |
| | resin | | | |
| 12 | 2 Part Structural Epoxy Adhesive | 1 | 1.4 | 1.4 |
| 13-34 | Phenolic resin impregnated S2 Glass | 12.0 | 1.96 | 23.52 |
| | composite comprising a glass woven roving | | | |
| | being a plain weave with a nominal 2 | | | |
| | rovings per cm in the warp direction and | | | |
| | 2 rovings per cm in the fill direction, and a | | | |
| | fabric weight, before prepregging, | | | |
| | of 815 ± 20 grams per square metre, | | | |
| | including surface size. The surface of the | | | |
| | woven roving being treated with an epoxy | | | |
| | silane coupling system and embedded in a | | | |
| | phenolic resin. | | | |

The hybrid constructions of the present invention provides appropriate structural strength to the passenger compartment to permit mounting of a range of appliqué armour to the passenger compartment so providing ballistic flexibility, while providing improved ballistic protection the unarmoured passenger compartment.

Typical appliqué armour for the walls of the vehicle [where greater protection might be required] could be of construction shown in Table 4:

TABLE 4

| | | | | Areal |
|---|---|---|---|---|
| | | Thickness | Density | Density |
| Layer | Material | (mm) | (g/cm³) | (kg/m²) |
| 10 | Polycarbonate | 0.75 | 1.2 | 0.9 |
| 11 | Polyurethane adhesive | 0.38 | 1.08 | 0.4104 |
| 12 | Alumina (98%) | 7 | 3.8 | 26.6 |
| | 30 mm A/F Hexagonal Tiles | | | |
| 13 | Polyurethane adhesive | 0.38 | 1.08 | 0.4104 |
| 14 | Polycarbonate | 0.75 | 1.2 | 0.9 |

Total areal density ~29.2 kg/m²

Whereas the roof might be of lighter construction as shown in Table 5.

TABLE 5

| | | | | Areal |
|---|---|---|---|---|
| | | Thickness | Density | Density |
| Layer | Material | (mm) | (g/cm³) | (kg/m²) |
| 10 | Polycarbonate | 0.75 | 1.2 | 0.9 |
| 11 | Polyurethane | 0.38 | 1.08 | 0.4104 |
| 12 | Alumina (98%) | 3.5 | 3.8 | 26.6 |
| | 30 mm A/F Hexagonal Tiles | | | |
| 13 | Polyurethane | 0.38 | 1.08 | 0.4104 |
| 14 | Polycarbonate | 0.75 | 1.2 | 0.9 |

Total areal density ~15.9 kg/m²

Although the invention has been illustrated using aramid, equivalent or even better weight savings could be achieved using a polyethylene/GFRP composite construction, although at higher cost.

The above description is exemplary only and various modifications will be apparent to the person skilled in the art while remaining within the scope of the appended claims.

1. A vehicle comprising
a composite passenger compartment comprising a structural shell formed wholly or in part of a glass fibre-containing composite material comprising a plurality of layers of fibrous material bonded with a resin;
appliqué armour mounted to the composite passenger compartment characterised in that the plurality of layers of fibrous material comprise both glass fibres and fibres providing in composite form a greater ballistic resistance per unit mass than the glass fibre.

2. A vehicle as claimed in claim 1, in which said fibres providing a greater ballistic resistance per unit mass than the glass fibre comprise fibres selected from the group aramid fibres, ultra-high molecular weight polyethylene fibres, polybenzoxazole (PBO) fibres, carbon fibres, silk fibres, polyamide fibres, polyester fibres, poly{2,6-diimidazo[4,5-b:40; 50-e]-pyridinylene-1,4(2,5-dihydroxy)phenylenel (“PIPD”) fibres, and mixtures thereof.

3. A vehicle as claimed in claim 2, in which said aramid fibres comprise para-aramid fibres.

4. A vehicle as claimed in any of claim 1, in which the plurality of layers of fibrous material comprise:
a plurality of layers comprising glass fibre
a plurality of layers comprising fibres providing in composite form a greater ballistic resistance per unit mass than the glass fibre.

5. A vehicle as claimed in claim 1, in which at least one of said layers comprises a woven fabric.

6. A vehicle as claimed in claim 1, in which at least one of said layers comprises a unidirectional fabric.

7. A vehicle as claimed in claim 1, in which the composite material comprises at least five of said layers of fibrous material.

8. A vehicle as claimed in claim 1, in which the composite material in part at least of the structural shell comprises carbon fibres.

9. A vehicle as claimed in claim 1, in which the appliqué armour is mounted in spaced relationship to the passenger compartment.

10. A vehicle as claimed in claim 1, in which pre-defined mounting points are provided on the composite passenger compartment and engage with mounting fixtures to secure the appliqué armour to the passenger compartment.

11. A vehicle comprising a composite passenger compartment as set out in claim 1, and configured for mounting correspondingly shaped appliqué armour to.

12. A vehicle as claimed in claim 11, in which pre-defined mounting points are provided on the composite passenger compartment to engage with mounting fixtures for securing the appliqué armour to the passenger compartment.

13. A kit of parts comprising a vehicle as claimed in claim 11, and correspondingly shaped appliqué armour pieces for mounting to said vehicle.
